(19) United States
(12) Patent Application Publication
(10) Pub. No.: US 2005/0015237 A1
(43) Pub. Date: Jan. 20, 2005

(54) Process, computerized device and computer program for assisting the vowelization of Arabic language words

(76) Inventor: Fathi Debili, Fontenay Aux Roses (FR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/621,548

(22) Filed: Jul. 17, 2003

(51) Int. Cl. G06F 17/28

(52) U.S. Cl. 704/2

(57) ABSTRACT

The invention relates to the vowelization of an Arabic language text, aided by computerized means. According to the invention, a first dictionary (D1) comprising unvowelized words is provided, and a second dictionary (D2) comprising groups of at least one vowelized word is provided, each group being stored in correspondence with an unvowelized word. For a current unvowelized word, a string of characters forming the current word is compared with strings of characters stored in the first dictionary, and a group of vowelized candidate words corresponding to the word identified from the first dictionary is extracted from the second dictionary.

### FIELD OF THE INVENTION

The invention relates to the vowelization of an Arabic language text, aided by computerized means.

### BACKGROUND OF THE INVENTION

Written Arabic provides chiefly two types of characters. A first type relates to the consonants, which constitute the body of the text. A second type relates to the vowels, which, in written Arabic, are added to the consonants by adding vowelization marks above or below each consonant.

Generally, texts published in Arabic comprise words represented solely by their consonants. Only instructional works for learning the Arabic language depict the consonants together with the vowelization marks.

Referring to FIG. 1a, the word represented in this figure comprises three successive letters 1, 2 and 3, corresponding respectively to the consonants K, T and B. This word, in its context, customarily signifies “he has written” and is read KATABA. A reader of an Arabic text, with a fluent command of this language, will therefore naturally interpret the succession of the three letters of FIG. 1a as corresponding to the word KATABA, which, when it is vowelized, exhibits horizontal bars 4 featuring above the letters 1, 2 and 3, as shown in FIG. 1b. Referring to FIG. 1b, it will thus be understood that these horizontal bars 4, placed above the consonants K, T, B, correspond to the vowel A and a reader unfamiliar with the Arabic language can now deduce unambiguously from the expression represented in FIG. 1b that it is the word KATABA. However, referring to FIG. 1c, the unfamiliar reader would not know whether the unvowelized word of FIG. 1a corresponds:
to the right combination of vowels KATABA (bearing the reference A in FIG. 1c),
to the erroneous combination of vowels KATABO (bearing the reference B in FIG. 1c),
to the erroneous combination of vowels KOTOBO (bearing the reference C in FIG. 1c), or to any other combination out of 27 possible combinations of these three consonants.

Specifically, there are in total 9 possible vowelization marks for a consonant (a, o, i, an, oun, in, no vowel associated with the consonant, hamza and chedda).

This difficulty is made more acute when certain unvowelized words may be read according to a plurality of possible interpretations. For example, the unvowelized word “man” may equally well be read “man” or “foot”, since the word “foot”, in Arabic, exhibits the same succession of consonants as the word “man”.

In other currently envisaged applications such as voice synthesis (involving converting written characters into voiced speech signals), the vowelization of the words appears to be necessary since a simple succession of consonants does not by itself allow the construction of an exact speech signal.

Furthermore, manual vowelization of a complete text, edited electronically, is laborious since the operator must systematically actuate a key for a consonant and at least two keys to furthermore edit the vowelization mark associated with this consonant (in particular the “SHIFT” key and another key of the keyboard).

Thus, there is today a real requirement for automatic vowelization of words in Arabic.

A process aided by computerized means and based on the chopping of words into a plurality of segments such as, in particular, a prefix, a radical, a suffix, is known for this purpose. Following this example, each type of prefix is stored in a first dictionary, each type of radical is stored in a second dictionary and each type of suffix is stored in a third dictionary. One proceeds in the same way for conjugated verbs. Ultimately, this process provides a multiplicity of dictionaries forming databases that are stored in a memory of the aforesaid computer means.

Thus, a word to be vowelized is chopped into several segments. Each segment is compared with a corresponding segment in the dictionary which is suitable for this type of segment. Vowelization rules coded in the form of computer program instructions define the vowelization which must be applied to this segment. Finally, the vowelized word is reconstructed by concatenating the various vowelized segments.

This process, although promising, exhibits numerous errors in its implementation. By way of illustration, it will for example be understood that the word “INFORMATION” comprises the radical “INFORM-” and the same suffix “-ATION” as the word “PERTURBATION”. However, the word “NATION” cannot be chopped up in the same way with the single letter “N-”, on the one hand, and the succession of letters “-ATION”, on the other hand. The same problem arises in Arabic.

### SUMMARY OF THE INVENTION

The present invention aims to improve the situation. Based on a very different approach, it proposes for this purpose a process for the vowelization of an Arabic language text, aided by computer means, wherein:
a) a first memory area is provided, in which a first dictionary comprising unvowelized words is stored,
b) a second memory area is provided, in which a second dictionary comprising groups of at least one vowelized word is stored, each group being stored in correspondence with an unvowelized word of said first dictionary,
c) for a current unvowelized word, a string of characters forming at least said current word is compared with strings of characters stored in the first memory area, so as to isolate at least one word from the first dictionary comprising the same character string as the current word, and
d) a group of vowelized candidate words corresponding to said isolated word from the first dictionary is extracted from the second dictionary.

The present invention is also aimed at a computerized device for assisting the vowelization of an Arabic language text, comprising:
a first memory area in which a first dictionary comprising unvowelized words is stored,
a second memory area in which a second dictionary comprising groups of at least one vowelized word is stored, each group being stored in correspondence with an unvowelized word of said first dictionary,
a memory area in which are stored instructions of a computer routine suitable for:
c) comparing, for a current unvowelized word, a string of characters forming at least said current word with strings of characters stored in the first memory area, so as to isolate at least one word from the first dictionary comprising the same character string as the current word, and
d) extracting, from the second dictionary, a group of vowelized candidate words corresponding to said isolated word from the first dictionary.

In this regard, the present invention is also aimed at a computer program for assisting the vowelization of an Arabic language text, stored in a memory of a computerized device or, in an equivalent manner, on a medium intended to cooperate with a reader of a computerized device, comprising:
a first database devised according to a first dictionary comprising unvowelized words,
a second database devised according to a second dictionary comprising groups of at least one vowelized word, each group of the second base being indexed in correspondence with an unvowelized word of the first base, and
a computer routine suitable for:
c) comparing, for a current unvowelized word, a string of characters forming at least said current word with strings of characters stored in the first memory area, so as to isolate at least one word from the first dictionary comprising the same character string as the current word, and
d) extracting, from the second dictionary, a group of vowelized candidate words corresponding to said isolated word from the first dictionary.

It will thus be understood that vowelization, within the meaning of the invention, is based solely on two dictionaries, one comprising unvowelized words and the other comprising groups of vowelized words. It will be seen in the description, given hereinafter, of a preferred embodiment and of variants of this embodiment how a vowelized candidate word is selected as replacement for an unvowelized current word.

### BRIEF DESCRIPTION OF THE DRAWINGS

Other characteristics and advantages of the invention will become apparent on examining the detailed description hereinafter, and the appended drawings in which:

FIG. 1a illustrates an unvowelized Arabic word,

FIG. 1b illustrates the word of FIG. 1a, but now vowelized,

FIG. 1c illustrates the word of FIG. 1a, with several possible vowelizations of this word,

FIG. 2 diagrammatically represents a computerized device for the implementation of the present invention,

FIG. 3 diagrammatically represents the content of memory areas of a memory of the central unit 24 of FIG. 2,

FIGS. 4a, 4b and 4c respectively represent a text comprising an unvowelized sentence, a vowelized sentence without casual vowels and a vowelized sentence with casual vowels,

FIG. 5 represents a general flow chart of the process according to a preferred embodiment of the invention,

FIG. 6 represents a dialogue box implemented by a man/machine interface module, for offering possible vowelizations of a current word, and

FIG. 7 represents a dialogue box offering possible grammatical labels of a current word.

### MORE DETAILED DESCRIPTION

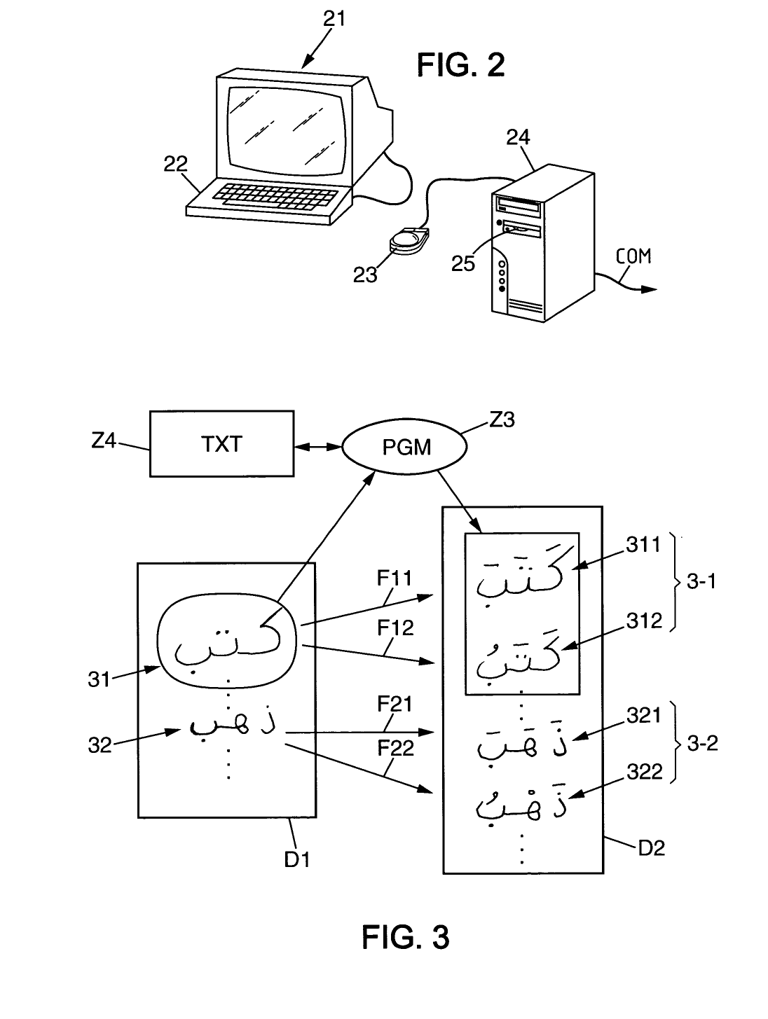

Reference is firstly made to FIG. 2 in which a computerized device conventionally comprises a central unit 24, to which are linked a display screen 21, an entry facility such as a keyboard 22 or a mouse 23, as well as an interface COM for communication, for example with a remote server, via an extended network of the INTERNET type. The central unit 24 furthermore comprises a reader 25 suitable for co-operating with a memory medium such as a CD-ROM, a DVD-ROM, a diskette, or any other memory medium. It will thus be understood that a computer program, within the meaning of the invention, may be stored on a memory medium of this type, while updates of the aforesaid dictionaries may be downloaded from the remote server or else obtained on another memory medium.

FIG. 3 represents a structure of a memory (for example of ROM type) in which are stored the first and second aforesaid dictionaries. It is indicated that the central unit 24 comprises a memory, for example a permanent memory of ROM type, in which are stored in digital form successions of Arabic characters forming words of the first and second dictionaries.

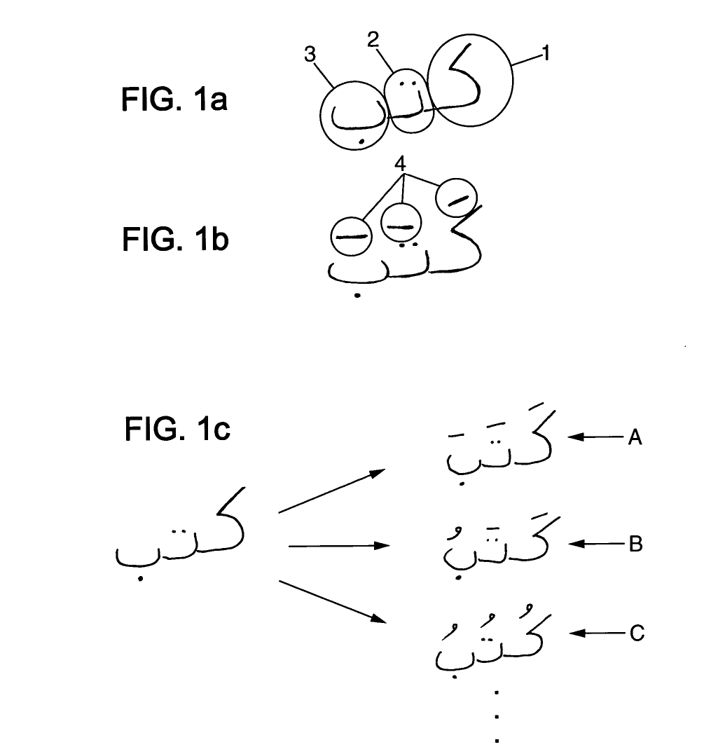

A first memory area D1 stores a first dictionary comprising unvowelized words 31, 32. A second memory area D2 stores a second dictionary comprising groups 3-1, 3-2 of one or more vowelized words 311, 312; 321, 322. Preferably, each group 3-1, 3-2 of the second dictionary D2 is stored in correspondence with an unvowelized word 31, 32 of the first dictionary D1, as illustrated by the correspondence arrows F11, F12, F21, F22 in FIG. 3. For example, the succession of the three consonants K, T, B (word 31) of FIG. 1a is present in the first dictionary D1 and the word KATABA 311 is present in the second dictionary D2.

It is indicated that, in a preferred embodiment, only the vowelized words that have a meaning are listed in the aforesaid second dictionary. However, as a variant, provision may be made to form a second initial dictionary comprising all the possible combinations of vowels for a given succession of consonants, while a user deletes from the second dictionary, in tandem with the use thereof, the deviant combinations that correspond to words that have no meaning. In this case, the second dictionary is formed by learning, by eliminating the deviant combinations from the memory area D2.

However, in the preferred embodiment, the second dictionary is constructed initially with vowelized words that have a meaning, so as to afford pleasant and user-friendly use of the program within the meaning of the invention.

Of course, for a computer program for assisting vowelization within the meaning of the invention, stored in a memory of a computerized device or on a medium capable of co-operating with a reader of a computerized device, the first and second dictionaries take the form respectively:
of a first database D1 whose structure is devised according to the first dictionary which comprises unvowelized words, and
of a second database D2 whose structure is devised according to the second dictionary which comprises groups of at least one vowelized word.

Each group of the second database D2 is indexed in correspondence with an unvowelized word of the first database D1, as also shown by the correspondence arrows F1 to F22 of FIG. 3.

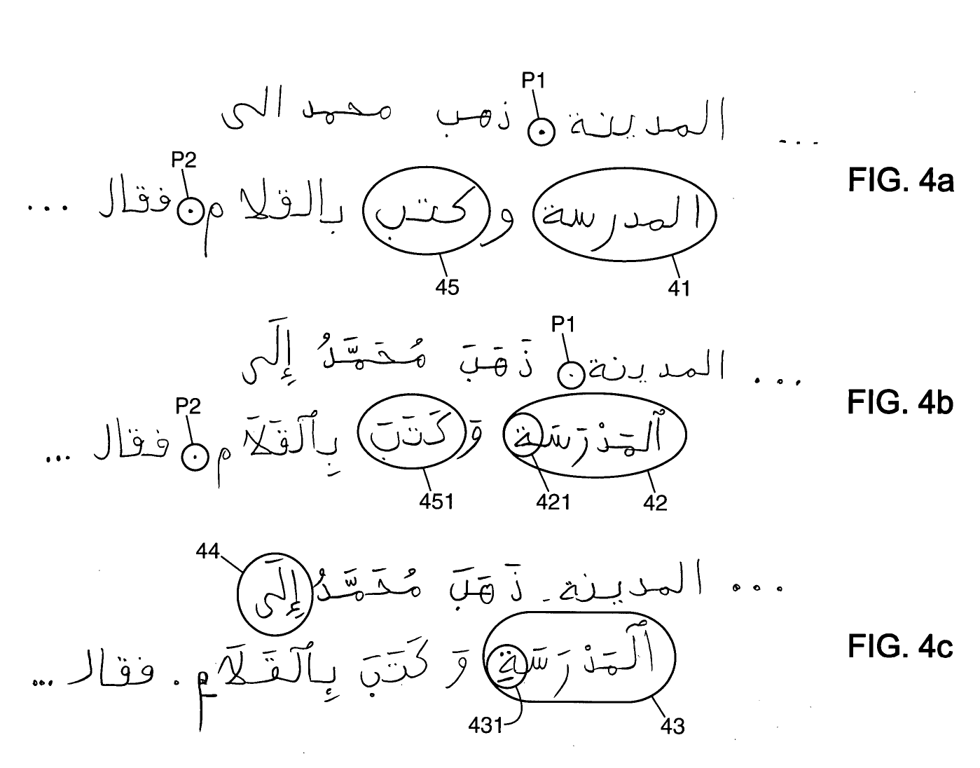

Reference is now made to FIGS. 4a and 4b which respectively represent an unvowelized text containing a complete sentence delimited by two full stops P1 and P2 and a partially vowelized text containing said sentence delimited by the full stops P1 and P2. It is recalled that Arabic is read from right to left. It will thus be understood that a succession of words may take the form of a complete sentence defined by a string of characters between two punctuation characters P1 and P2, the various words of this sentence possibly being vowelized as a function of their position in the sentence, as will be seen later on.

It is simply indicated here that the text of FIG. 4b does not systematically comprise so-called “casual” vowels which are usually allocated at the end of a word. On the other hand, the text of FIG. 4c is completely vowelized and furthermore comprises the casual vowels that appear in particular at the last letter 431 of the word 43 (with a horizontal stroke under this last letter 431 and to be compared with the unvowelized last letter 421 of the word 42 (partially vowelized) of FIG. 4b).

Furthermore, the unvowelized word, referenced 45, which comprises the character succession 1, 2, 3 of FIG. 1a, corresponding to the consonants K, T, B will be recognized in FIG. 4a. The vowelized word 451 which corresponds to the word KATABA of FIG. 1b and vowelized by horizontal strokes 4 above the consonants, which are representative of the vowel “A”, will also be recognized in FIG. 4b.

These sentences of FIGS. 4a, 4b and 4c thus appear on the screen 21 of the computerized device and the characters of the texts forming these sentences are conventionally stored in TXT digital form (FIG. 3) in a work memory Z4 (for example of RAM type) of the central unit 24 of the computerized device.

Referring again to FIG. 3, the computerized device furthermore comprises a memory area Z3 in which are stored instructions of a computer program PGM suitable for:
comparing, for an unvowelized current word (bearing the reference 45 in FIG. 4a), a string of characters (in this instance the consonants 1, 2 and 3 of FIG. 1a) forming this current word 45, with strings of characters 31 stored in the first memory area D1, so as to isolate the word 31 from the first dictionary D1 comprising the same string of characters as the current word 45, and
extracting from the second dictionary D2 a group 3-1 of vowelized candidate words 311, 321 that correspond (arrows F11 and F12) to the isolated word 31 from the first dictionary D1.

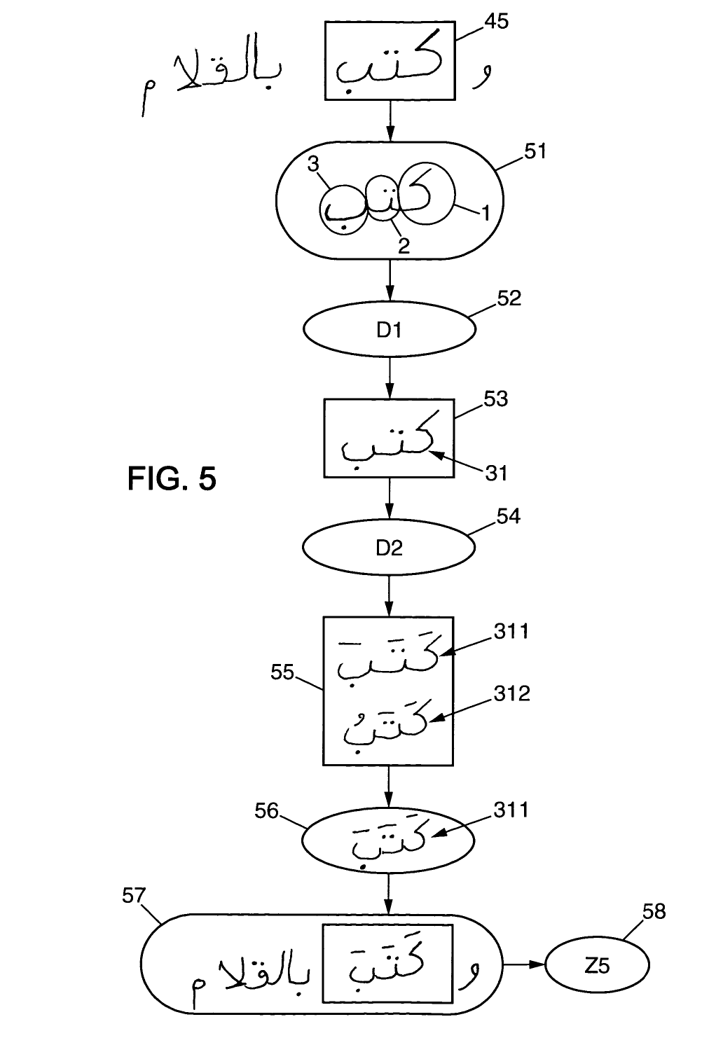

Reference is now made to FIG. 5 to describe the running of the computer routine of the program PGM. Here one seeks to vowelize a word 45 which appears in a text electronically edited on the screen 21 of FIG. 2. This routine pinpoints firstly, for example by character recognition, in step 51, the characters (the consonants 1, 2, 3) of the unvowelized word 45. The routine then performs, in step 52, a comparison with unvowelized words listed in the dictionary D1 so as to isolate therefrom, in step 53, an unvowelized word 31 exhibiting the same succession of consonants 1, 2, 3.

In step 54, the program PGM determines, as a function of the memory location in the memory area D1 of the word 31, the memory location of the group 3-1 in the memory area D2 and comprising the vowelized words 311 and 312, of the second dictionary of vowelized words. In step 55, the program PGM extracts from the memory area D2 the group of candidate words 311 and 312 comprising the same succession of consonants but vowelized differently.

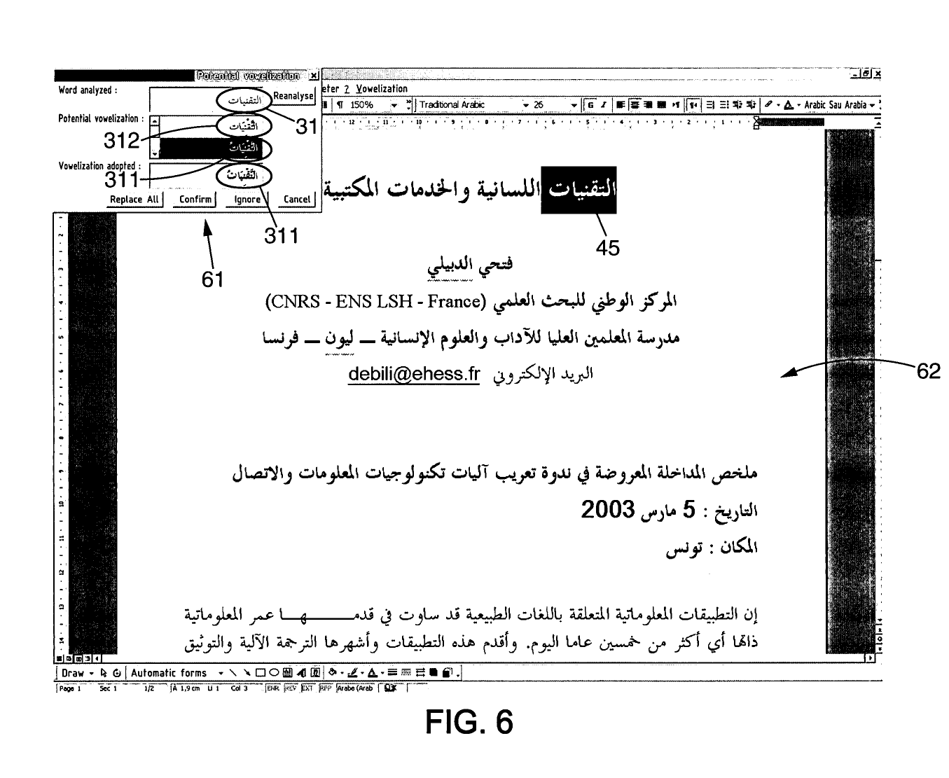

In a preferred embodiment, there is furthermore provided a man/machine interface module, preferably in the form of computer instructions forming part of the program PGM. Shown in FIG. 6 is a screen shot 21 depicting, for an electronically edited text 62, a dialogue box 61 which is one of the functionalities of this man/machine interface. For a current unvowelized word 45, selected by a user (on the basis of an entry facility such as the mouse 23) and which appears, for this reason, contrasted in the text 62, the dialogue box 61 indicates firstly which is the word 31 analysed in correspondence in the first dictionary D1. Next, the dialogue box 61 offers potential vowelizations of this current word 45, which correspond to candidate vowelized words 312 and 311 of the second dictionary D2, for the same succession of consonants as the word 31 of the first dictionary. Thus, in the second panel of the dialogue box 61, the man/machine interface offers a user a list of choices of the candidate words 311 and 312.

Referring again to FIG. 5, in a preferred embodiment, the user chooses, in step 56, a candidate word 311 from the list of candidate words 311, 312 of the group of words 3-1. In step 57, the vowelized word chosen 311 automatically replaces the unvowelized word 45 in the electronically edited text. It is specified moreover that the user's “choice” is stored in step 58, in a memory area Z5 of the computerized device. Preferably, this memory area Z5 is in correspondence with the memory area D2 in which the second dictionary is stored, in such a way as to enhance the latter. More particularly, the word chosen 311, thus vowelized, is stored with the words preceding it and/or following it in a part of the edited text. Preferably, the chosen word 311 is stored together with the complete sentence in which it appears, with a view to improving the vowelization within the meaning of the present invention, by learning, as will be seen later on. It is simply indicated here that, if the current word 45 to be vowelized forms part of a current succession of words, such as a complete sentence, following the choice of a word 311 by the user (from the list of candidate words 311, 312), the chosen vowelized word 311 and the succession of words in which it is included are stored in the aforesaid memory area Z5.

Thus, in the third panel of the dialogue box 61 of FIG. 6, the man/machine interface indicates to the user the chosen word 311, which will be edited in the text 62 as replacement for the unvowelized word 45 and preferably stored with a succession of words preceding it and/or following it.

Reference is again made to FIGS. 4a and 4c to describe hereinafter a vowelization of words as a function of their context.

FIG. 4a deals in particular with the first word of the sentence which follows the full stop P1, given that Arabic is read from right to left. This first word is recognized from the sentence in FIG. 3 which corresponds to the unvowelized expression 32 of the first dictionary D1. Now, this unvowelized word 32 admits two possible vowelizations 321 (signifying the expression “he has gone”) and 322 (signifying the metal “gold”) in the second dictionary D2.

Generally, in the Arabic language, a word beginning a sentence corresponds to a verb. Thus, the word which follows the first full stop P1 of FIG. 4a is a verb whose vowelized form corresponds almost certainly to the conjugated verb 321 of the second dictionary D2 of FIG. 3.

Thus, if the current word forms part of a succession of words, a string of characters forming this succession of words comprising the current word is compared, in a broader manner, with strings of characters stored in the aforesaid area Z5 in correspondence with the second memory area D2, so as to identify a plurality of words comprising one and the same string of characters as this succession of words. This step corresponds, in a broader perspective, to step 51 represented in FIG. 5.

It is then indicated that the program PGM can comprise instructions for performing this comparison “broadened to a succession of words”. For example, for a complete sentence, a computer routine may be provided for isolating the characters of the complete sentence between the two punctuation marks P1 and P2.

Next, for the current word to be vowelized, a vowelized word (here the verb 321) is selected from the group of vowelized candidate words extracted from the second dictionary D2 as a function of the succession of identified words and, in particular, of a position of the current word 32 in this succession of identified words. Here, the word 32 begins the sentence and therefore corresponds to the vowelized verb 321.

Advantageously, it is then possible to proceed to an automatic replacement, in the electronically edited text, of the unvowelized current word 32 with the vowelized word 321, selected automatically from the group of candidate words 321 and 322.

It will thus be understood that this automatic vowelization is advantageously effected here by storing complete sentences and/or successions of words, whose vowelization is enabled by the user, in tandem with the use of the computer software for assisting vowelization, hence by learning. Computer learning techniques are known per se. It is indicated for example that routines such as those used by the software ViaVoice® from the company Microsoft® are well suited to the determination of written characters by learning.

However, in case of uncertainty regarding vowelization, the man/machine interface advantageously offers the user a list of choices comprising words selected from candidate words of the second dictionary. This situation is represented in FIG. 6 where two possible vowelizations 312 and 311, which are consistent as a function of the context of the current word 45, are offered to the user. In a yet more advantageous manner, this list is hierarchized as a function of context, in order of relevance of the vowelizations offered. In particular, this hierarchy may be deduced by learning, by analysing the form of vowelization preferred by the user and which recurs most often during use.

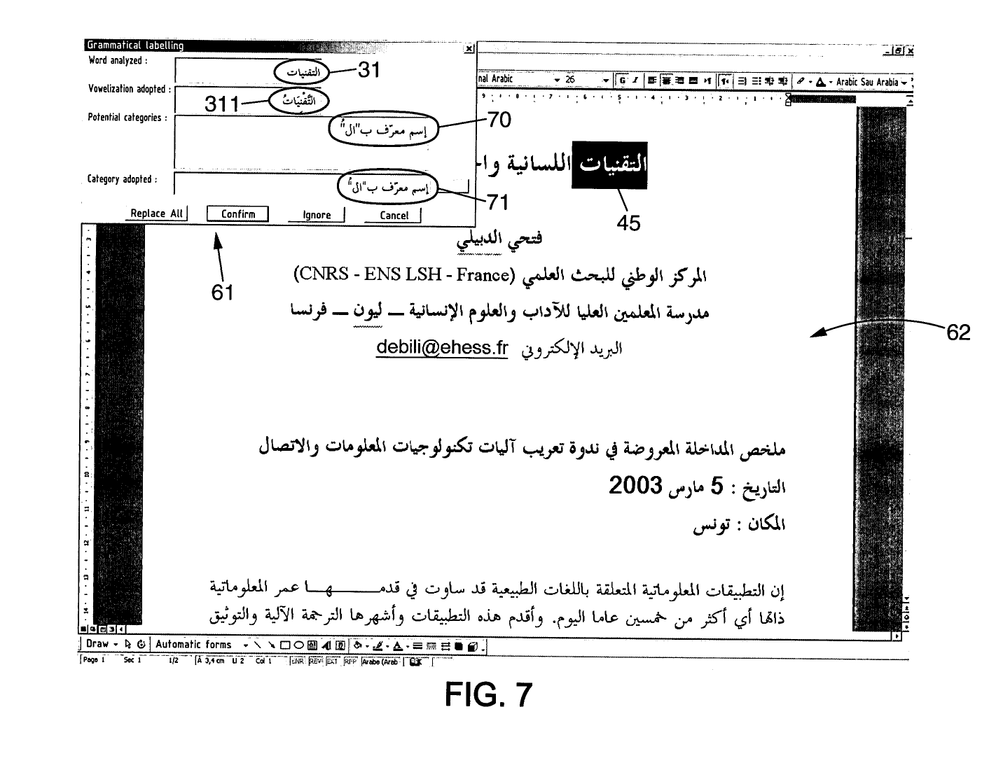

Referring to FIG. 7, advantageously, grammatical labels in correspondence with each word 311 in each group of 3-1 of the second dictionary D2 are stored in a memory area (not represented), so that the man/machine interface, in particular the dialogue box 61 of FIG. 7, furthermore indicates to the user a grammatical label 70 of each of the words selected from the candidate words 311, 312. If appropriate, this grammatical label is enabled by the user, in the panel 71 of the dialogue box. It is indicated that this grammatical label corresponds for example to a syntactic description of a word, of the type “common noun, in the singular, definite, placed as subject in the sentence, etc.”. Of course, this grammatical label is defined and enabled as a function of the position of the analysed word 45 in the current sentence.

For this purpose, there is provided a memory area (for example again in correspondence with the second memory area D2) for furthermore storing grammatical labels 70 each corresponding to a vowelized word 311 of the second dictionary.

As shown by FIGS. 6 and 7, it is specified that the computer program PGM, for the implementation of the invention, as well as the man/machine interface module, are compatible with electronic means of Arabic language text editing, such as the MICROSOFT WORD® software.

Described hereinafter is another type of possible automatic vowelization, termed “casual”. Casual vowels are usually allocated to consonants at the end of a word, according to the context of this word in a sentence. For example, the word 42 of FIG. 4b, within its context, admits a vowelization of its last letter 421, by the sound “i” which corresponds to a horizontal bar 431 under this end letter.

It is recalled that there is, in the Arabic language, a plurality of possible declensions for a common noun, such as nominative (definite or indefinite), accusative (definite or indefinite), ablative (definite or indefinite), etc. To these declensions correspond end of word vowelizations with the following sounds:

| | |
|---|---|
| “O” = | definite nominative |
| “OUN” = | indefinite nominative |
| “A” = | definite accusative |
| “AN” = | indefinite accusative |
| “I” = | definite ablative |
| “IN” = | indefinite ablative, etc. |

For example, referring again to FIGS. 4b and 4c, the preposition corresponding to the word 44 is pinpointed in the succession of words featuring the word 43.

This preposition 44 necessarily entails a declension in the ablative of the word 43 which follows, with automatic casual vowelization by the sound “i” of the last letter 431 of the word 43.

Thus, as before, the computer routine of the program PGM comprises instructions for comparing the current succession of words of FIG. 4b, with previously stored successions of words. As appropriate, the preposition 44 is identified, with a position which precisely precedes the word 42 to be vowelized. A routine of the program PGM then selects, as a function of this comparison, the vowelized word 43 ending with the sound “i” which corresponds to a declension in the ablative, entailed by the position of this preposition 44 with respect to the word 43. It is indicated that the casual vowelization is offered as an option by the man/machine interface of the program PGM, in a preferred embodiment.

In a general manner, it will be understood that the steps described hereinabove, in particular those with reference to FIG. 5, are implemented by the running of instructions or of computer routines of the program PGM, which is therefore intended to be installed in a memory of a machine or of a computerized device of the type represented in FIG. 2. Initially, this program, for example stored on CD-ROM, comprises the first and second memory areas D1 and D2 devised in the form of databases (with, as appropriate, the data of the grammatical labels), which may be loaded and copied into memory (for example permanent ROM type memory) of the aforesaid computerized device. It will be understood that these databases, once copied into the memory of the device, can then be enhanced, in particular by learning. In particular, the same holds in respect of said memory area Z5 in correspondence with the second memory area, which is intended to store the successions of words or of complete sentences. The database stored in the area Z5 (in a memory of the device) is thus enhanced in tandem with the use thereof.

1. Process for the vowelization of an Arabic language text, aided by computer means, wherein:
a) a first memory area is provided, in which a first dictionary comprising unvowelized words is stored,
b) a second memory area is provided, in which a second dictionary comprising groups of at least one vowelized word is stored, each group being stored in correspondence with an unvowelized word of said first dictionary,
c) for a current unvowelized word, a string of characters forming at least said current word is compared with strings of characters stored in the first memory area, so as to isolate at least one word from the first dictionary comprising the same character string as the current word, and
d) a group of vowelized candidate words corresponding to said isolated word from the first dictionary is extracted from the second dictionary.

2. Process according to claim 1, wherein there is provided a computer routine suitable for performing said comparison of the character strings and said extraction of the group of candidate words.

3. Process according to claim 1, wherein there is furthermore provided a man/machine interface suitable for offering a user a list of choices of said candidate words.

4. Process according to claim 1, wherein, said current word forming part of a succession of words,
c1) a string of characters forming said succession of words comprising the current word is compared with strings of characters stored in a memory area in correspondence with the second memory area, so as to identify a plurality of words comprising one and the same string of characters as said succession of words, and
d2) for said current word, at least one vowelized word is selected from said group of vowelized candidate words as a function of the succession of identified words and of a position of the current word in said succession of identified words.

5. Process according to claim 4, wherein said succession of words is a complete sentence defined by a string of characters between two punctuation characters.

6. Process according to claim 4, wherein said current word is automatically replaced in an electronically edited text with said vowelized word, selected from the group of candidate words.

7. Process according to claim 3 and claim 4, wherein the man/machine interface offers a user a list of choices comprising words selected from said candidate words.

8. Process according to claim 7, wherein grammatical labels are furthermore stored in correspondence with each word in each group of the second dictionary, and wherein the man/machine interface furthermore indicates to the user a grammatical label of each of the words selected from said candidate words.

9. Process according to claim 3, wherein, said current word forming part of a current succession of words,
following the choice of a word by said user from the list of candidate words, the chosen word is stored with the succession of words, in a memory area in correspondence with said second memory area.

10. Process according to claim 8 and claim 4, wherein the selecting of the vowelized word from said group of vowelized candidate words is performed by learning, by comparing the current succession of words with successions of words which are stored in said memory area in correspondence with the second memory area.

11. Computerized device for assisting the vowelization of an Arabic language text, comprising:
a first memory area in which a first dictionary comprising unvowelized words is stored,
a second memory area in which a second dictionary comprising groups of at least one vowelized word is stored, each group being stored in correspondence with an unvowelized word of said first dictionary,
a memory area in which are stored instructions of a computer routine suitable for:
c) comparing, for a current unvowelized word, a string of characters forming at least said current word with strings of characters stored in the first memory area, so as to isolate at least one word from the first dictionary comprising the same character string as the current word, and
d) extracting a group of vowelized candidate words corresponding to said isolated word from the first dictionary from the second dictionary.

12. Computerized device according to claim 11, furthermore comprising a man/machine interface suitable for offering a user a list of choices of said candidate words.

13. Computerized device according to claim 11, wherein, said current word forming part of a succession of words, said computer routine is devised so as to:
c1) compare a string of characters forming said succession of words comprising the current word with strings of characters stored in a memory area in correspondence with the second memory area, so as to identify a plurality of words comprising one and the same string of characters as said succession of words, and
d2) for said current word, select at least one vowelized word from said group of vowelized candidate words as a function of the succession of identified words and of a position of the current word in said succession of identified words.

14. Computerized device according to claim 13, wherein said succession of words is a complete sentence defined by a string of characters between two punctuation characters, and wherein said computer routine is devised so as to isolate the characters of the complete sentence between the two punctuation marks.

15. Computerized device according to claim 11, furthermore comprising electronic means of Arabic language text editing, wherein said computer routine is able to cooperate with said text editing means.

16. Computerized device according to claim 15 and claim 13, wherein the computer routine is devised to automatically replace in an edited text said current word with said vowelized word, selected from the group of candidate words.

17. Computerized device according to claim 12 and claim 13, wherein the man/machine interface is devised so as to offer a list of choices comprising words selected from said candidate words.

18. Computerized device according to claim 12, wherein, said current word forming part of a current succession of words,
the computer routine furthermore comprises instructions for storing the chosen word with said succession of words, in a memory area in correspondence with said second memory area.

19. Computerized device according to claim 18 and claim 13, wherein the computer routine comprises instructions for comparing the current succession of words with successions of words stored in said memory area in correspondence with the second memory area, and selecting, as a function of this comparison, at least one vowelized word from said group of vowelized candidate words.

20. Computerized device according to claim 17, comprising a memory area for furthermore storing grammatical labels in correspondence with each word in each group of the second dictionary, and wherein the man/machine interface furthermore indicates to the user a grammatical label of each of the words selected from said candidate words.

21. Computer program for assisting the vowelization of an Arabic language text, stored in a memory of a computerized device or on a medium intended to cooperate with a reader of a computerized device, comprising:
a first database devised according to a first dictionary comprising unvowelized words,
a second database devised according to a second dictionary comprising groups of at least one vowelized word, each group of the second base being indexed in correspondence with an unvowelized word of the first base, and
a computer routine suitable for:
c) comparing, for a current unvowelized word, a string of characters forming at least said current word with strings of characters stored in the first memory area, so as to isolate at least one word from the first dictionary comprising the same character string as the current word, and
d) extracting a group of vowelized candidate words corresponding to said isolated word from the first dictionary from the second dictionary.

22. Computer program according to claim 21, intended to be installed in a memory of a computer machine and comprising a man/machine interface module suitable for offering a user a list of choices of said candidate words.

23. Computer program according to claim 21, wherein, said current word forming part of a succession of words, the program comprises instructions for:
c1) compare a string of characters forming said succession of words comprising the current word with strings of characters stored in a memory area in correspondence with the second memory area, so as to identify a plurality of words comprising one and the same string of characters as said succession of words, and
d2) for said current word, selecting at least one vowelized word from said group of vowelized candidate words as a function of the succession of identified words and of a position of the current word in said succession of identified words.

24. Computer program according to claim 23, wherein said succession of words is a complete sentence defined by a string of characters between two punctuation characters, and wherein the program comprises instructions for isolating the characters of the complete sentence between the two punctuation marks.

25. Computer program according to claim 21, compatible and able to cooperate with an Arabic language text editing program.

26. Computer program according to claim 25 and claim 23, intended to be installed in a memory of a computerized device and comprising instructions for automatically replacing in an edited text said current word with said vowelized word, selected from the group of candidate words.

27. Computer program according to claim 22 and claim 23, wherein the man/machine interface is devised so as to offer a list of choices comprising words selected from said candidate words.

28. Computer program according to claim 22, wherein,
said current word forming part of a current succession of words,
the computer program furthermore comprises instructions for storing the chosen word with said succession of words, in a memory area in correspondence with said second memory area.

29. Computer program according to claim 28 and claim 23, wherein the computer program comprises instructions for comparing the current succession of words with successions of words stored in said memory area in correspondence with the second memory area, and selecting, as a function of this comparison, at least one vowelized word from said group of vowelized candidate words.

30. Computer program according to claim 27, comprising a database stored in correspondence with each word of the second dictionary and comprising grammatical labels for each word in each group of the second dictionary, wherein the man/machine interface comprises instructions for furthermore indicating to the user a grammatical label of each of the words selected from said candidate words.
